(19) United States
(12) Patent Application Publication
(10) Pub. No.: US 2005/0277437 A1
(43) Pub. Date: Dec. 15, 2005

(54) MOBILE PHONE BATTERY MODULE HAVING A CAMERA MODULE

(76) Inventors: Shu-Lang Dai, Chi-Lung City (TW); KUEI-PIN TSAI, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,987

(22) Filed: Jun. 11, 2004

(51) Int. Cl. H04M 1/00

(52) U.S. Cl. 455/556.1; 455/575.1; 455/572

(57) ABSTRACT

A battery module of a mobile phone includes a camera module for capturing digital images, a memory for storing digital images captured with the camera module, a first interface for connecting to the mobile phone for transmitting captured digital images from the battery module to the mobile phone, a battery cell for supplying electrical power, and a plurality of battery contacts for contacting corresponding battery connectors of the mobile phone and for providing electrical power supplied by the battery cell to the mobile phone.

### BACKGROUND OF INVENTION

1. Field of the Invention

The present invention relates to digital imaging, and more particularly, to a mobile phone battery having a camera module formed thereon for providing a mobile phone using the mobile phone battery with the functionality of a digital camera.

2. Description of the Prior Art

Mobile phones with built in digital camera functionality, also known as camera phones, have rapidly grown in popularity. Many people carry a mobile phone with them everywhere they go. Therefore, having a mobile phone that can take digital pictures allows users to take pictures quickly and conveniently.

Unfortunately, many people already own a mobile phone that is not a camera phone. Currently, there is no easy way to upgrade a mobile phone that is not a camera phone to provide the functionality of a camera phone. Although many people would like to own a camera phone, they have difficulty justifying the purchase of a new camera phone when they already have an existing mobile phone.

### SUMMARY OF INVENTION

It is therefore an objective of the claimed invention to introduce a mobile phone battery having a camera module formed thereon in order to solve the above-mentioned problems.

According to the claimed invention, a battery module of a mobile phone includes a camera module for capturing digital images, a memory for storing digital images captured with the camera module, a first interface for connecting to the mobile phone for transmitting captured digital images from the battery module to the mobile phone, a battery cell for supplying electrical power, and a plurality of battery contacts for contacting corresponding battery connectors of the mobile phone and for providing electrical power supplied by the battery cell to the mobile phone.

It is an advantage of the claimed invention that mobile phones that do not offer digital camera functionality can quickly and easily become camera phones by swapping out a normal battery with the battery module of the present invention having the camera module formed thereon. Thus, older mobile phones can be converted into camera phones, eliminating the need to buy a new camera phone.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a mobile phone and a battery module according to the present invention.

FIG. 2 is a diagram of a front side of the battery module according to the present invention.

FIG. 3 is a side view of the mobile phone having the battery module installed according to the present invention.

### DETAILED DESCRIPTION

The present invention battery module allows a regular mobile phone not having digital camera functionality to become a camera phone by simply inserting the battery module into the mobile phone.

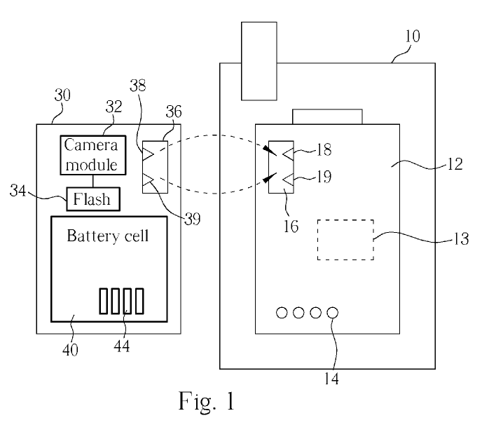

Please refer to FIG. 1. FIG. 1 is a diagram of a mobile phone 10 and a battery module 30 according to the present invention. A cavity 12 of the mobile phone 10 is formed for receiving the battery module 30. When a user of the mobile phone 10 wishes to use the mobile phone 10 as a camera phone, the user can swap out a normal battery of the mobile phone 10 with the battery module 30 shown in FIG. 1. A rear side of the battery module 30 is shown in FIG. 1. When the battery module 30 is inserted into the cavity 12 of the mobile phone 10, only a front side of the battery module 30 is visible. The rear side of the battery module 30 contains circuitry of the battery module 30 that a user does not need to access while utilizing the digital camera features of the mobile phone 10.

The battery module 30 contains a camera module 32, which contains the circuitry needed for taking digital pictures. The camera module 32 can be used for taking still pictures or dynamic pictures such as movie clips or animated picture sequences. Like other digital cameras, the camera module 32 may contain a CCD or CMOS image sensor. After the camera module 32 takes digital images, the digital images are stored in a flash memory 34 of the battery module 30. While the flash memory 34 may be replaced with other types of memory, the flash memory 34 is preferred for its nonvolatile nature when the mobile phone 10 is powered off.

The battery module 30 also contains a battery cell 40 for providing power to the electrical components of the battery module 30 such as the camera module 32 and the flash memory 34. In addition, the battery cell 40 provides power to the mobile phone 10 when the battery module 30 is inserted into the cavity 12 of the mobile phone 10. The battery module 30 contains battery contacts 44 that make electrical contact with corresponding battery connectors 14 of the mobile phone 10 for providing the mobile phone 10 with electrical power supplied by the battery cell 40.

The battery module 30 also contains a first interface 36 for communicating with an interface 16 of the mobile phone 10. Once digital images have been taken with the battery module 30, the digital images can be transferred from the battery module 30 to circuitry 13 of the mobile phone 10 through the first interface 36 and the interface 16. The first interface 36 and the interface 16 may communicate through a variety of protocols including the RS232 serial bus standard and the universal serial bus (USB) standard.

Most mobile phones 10 on the market today have at least two pins that are used for testing and other diagnostic purposes. If at least two pins are used, one of the pins will be a transmit (Tx) pin and another pin will be a receive (Rx) pin. Besides being used for diagnostic purposes, these two pins can also be used for performing serial communication between the mobile phone 10 and the battery module 30. As shown in FIG. 1, the interface 16 of the mobile phone 10 contains a transmit pin 18 and a receive pin 19. The first interface 36 of the battery module 30 contains a first pin 38 and a second pin 39 corresponding to the transmit pin 18 and the receive pin 19 for facilitating communication between the mobile phone 10 and the battery module 30. While many mobile phones already contain the transmit pin 18 and the receive pin 19, extending contacts may need to be added to the transmit pin 18 and the receive pin 19 so that the first and second pins 38 and 39 can make electrical contact with the transmit pin 18 and the receive pin 19. The advantage of using the transmit pin 18 and the receive pin 19 of the mobile phone 10 to transfer digital images from the battery module 30 to the mobile phone 10 is that the existing structure of the mobile phone 10 can be used, and no major changes have to be made to the hardware of the mobile phone 10 to accommodate the battery module 30.

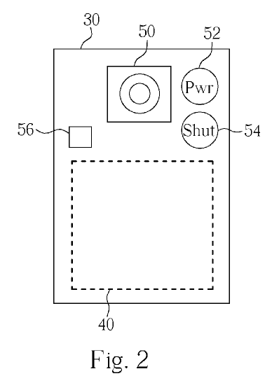

Please refer to FIG. 2. FIG. 2 is a diagram of a front side of the battery module 30 according to the present invention. Disposed on the front side of the battery module 30 is a camera lens 50 used for taking digital images in conjunction with the camera module 32 disposed on the rear side of the battery module 30. A simple user interface, including a power button 52 and a shutter button 54 are also disposed on the front side of the battery module 30 for enabling a user to take pictures with the battery module 30. The power button 52 allows the user to turn the camera module 32 and the flash memory 34 off when not using the mobile phone 10 as a camera phone. The shutter button 54 is similar to a shutter button on other cameras, and is used for controlling the camera lens 50 and the camera module 32 to take a digital photo.

Instead of using both the power button 52 and the shutter button 54, other possibilities exist for controlling the camera phone functions of the battery module 30. For instance, a single button can be used for controlling both the power and the shutter functions. If the single button is pressed for a time period in a first time range, a photograph can be taken. Similarly, if the single button is pressed for a time period in a second time range, the single button can act as a power button. Furthermore, keypad keys of the mobile phone 10 can also be used for controlling the battery module 30 to take digital photographs.

The battery module 30 can optionally have a second interface 56 for connecting the battery module 30 directly to a computer. In this way, pictures stored in the flash memory 34 of the battery module 30 can be downloaded onto the computer through the second interface 56. The second interface 56 can be any common interface such as serial, parallel, USB, or IEEE 1394. Of course, the mobile phone 10 may also contain an additional interface for connecting to a computer, but this may not be possible without making changes to the existing hardware structure of the mobile phone 10.

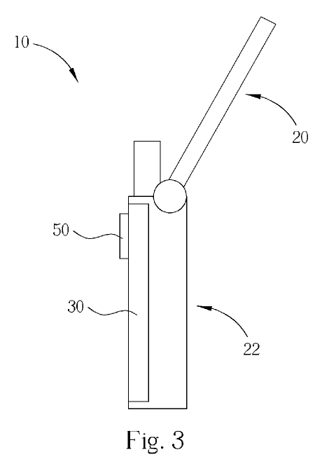

Please refer to FIG. 3. FIG. 3 is a side view of the mobile phone 10 having the battery module 30 installed according to the present invention. The mobile phone 10 shown in FIG. 3 has a clam-shell shape. A display 20 is located on an upper portion of the mobile phone 10, and a keypad 22 is located on a lower portion of the mobile phone 10. When the battery module 30 is installed in the cavity 12 of the mobile phone 10, the camera lens 50 of the battery module 30 points outward for taking digital photographs. Once a digital image has been captured, the image can be shown on the display 20 of the mobile phone 10 for review. Of course, other shapes can also be used for the mobile phone 10, and the mobile phone 10 is not limited to a clam-shell shape.

In summary, the present invention battery module can easily convert a normal mobile phone into a camera phone by simply replacing the battery of the mobile phone with the battery module of the present invention. Thus, older mobile phones can be converted into camera phones, eliminating the need to buy a new camera phone.

Those skilled in the art will readily appreciate that numerous modifications and alterations of the device may be made without departing from the scope of the present invention. Accordingly, the above disclosure should be construed as limited only by the metes and bounds of the appended claims.

1. A battery module of a mobile phone, the battery module comprising:
a camera module for capturing digital images;
a memory for storing digital images captured with the camera module;
a first interface for connecting to the mobile phone for transmitting captured digital images from the battery module to the mobile phone;
a battery cell for supplying electrical power; and
a plurality of battery contacts for contacting corresponding battery connectors of the mobile phone and for providing electrical power supplied by the battery cell to the mobile phone.

2. The battery module of claim 1 further comprising a first button for taking pictures when the first button is pressed.

3. The battery module of claim 2 further comprising a second button for powering the camera module on and off.

4. The battery module of claim 1 further comprising a first button for taking pictures when the first button is pressed for a period of time within a first predetermined range of times, and for powering the camera module on and off when the first button is pressed for a period of time within a second predetermined range of times.

5. The battery module of claim 1 wherein the first interface comprises first and second pins of the battery module electrically connecting to a receive pin and a transmit pin of the mobile phone for facilitating communication between the battery module and the mobile phone and for transmitting captured digital images from the battery module to the mobile phone.

6. The battery module of claim 1 wherein the first interface is an RS232 serial interface.

7. The battery module of claim 1 wherein the first interface is a universal serial bus (USB) interface.

8. The battery module of claim 1 further comprising a second interface for connecting to an external computer for transmitting captured digital images from the battery module to the external computer.

9. The battery module of claim 1 wherein the memory is a flash memory for storing the digital images in a nonvolatile manner.

10. A mobile phone capable of capturing digital images, the mobile phone comprising:
a housing;
a cavity in the housing formed for receiving a battery;
a battery module removably disposed in the cavity of the mobile phone housing, the battery module comprising:
a camera module for capturing digital images;
a memory for storing digital images captured with the camera module;
a first interface for electrically connecting to the mobile phone for transmitting captured digital images from the battery module to circuitry of the mobile phone;
a battery cell for supplying electrical power; and
a plurality of battery contacts for providing electrical power supplied by the battery cell to the mobile phone;
a plurality of battery connectors corresponding to the battery contacts of the battery module for receiving electrical power from the battery cell; and
an interface corresponding to the first interface of the battery module for transmitting digital images received through the first interface of the batter module to the circuitry of the mobile phone.

11. The mobile phone of claim 10 wherein the battery module further comprises a first button for taking pictures when the first button is pressed.

12. The mobile phone of claim 11 wherein the battery module further comprises a second button for powering the camera module on and off.

13. The mobile phone of claim 10 wherein the battery module further comprises a first button for taking pictures when the first button is pressed for a period of time within a first predetermined range of times, and for powering the camera module on and off when the first button is pressed for a period of time within a second predetermined range of times.

14. The mobile phone of claim 10 wherein the first interface of the battery module comprises first and second pins, the interface of the mobile phone comprises a receive pin and a transmit pin, and the first and second pins electrically connect to the receive pin and the transmit pin for facilitating communication between the battery module and the circuitry of the mobile phone and for transmitting captured digital images from the battery module to the circuitry of the mobile phone.

15. The mobile phone of claim 10 wherein the first interface is an RS232 serial interface.

16. The mobile phone of claim 10 wherein the first interface is a universal serial bus (USB) interface.

17. The mobile phone of claim 10 wherein the battery module further comprises a second interface for connecting to an external computer for transmitting captured digital images from the battery module to the external computer.

18. The mobile phone of claim 10 wherein the memory is a flash memory for storing the digital images in a nonvolatile manner.
